(19) United States
(12) Patent Application Publication
(10) Pub. No.: US 2002/0032715 A1
(43) Pub. Date: Mar. 14, 2002

(54) Task program control system and task program control method

(76) Inventor: Isao Utsumi, Tokyo (JP)

Correspondence Address: RABIN & CHAMPAGNE, PC, 1101 14TH STREET, NW, SUITE 500, WASHINGTON, DC, 20005, US

(21) Appl. No.: 09/940,850

(22) Filed: Aug. 29, 2001

(30) Foreign Application Priority Data
Sep. 7, 2000 (JP) 270925/2000

(51) Int. Cl. G06F 9/00

(52) U.S. Cl. 709/103

(57) ABSTRACT

Information of priorities of a plurality of tasks and orders-per-priority has been stored in a matrix circuit (1). A priority encoder (2) extracts a value of the highest priority from the matrix circuit (1). This value is held in a priority register (18). An order-per-priority control circuit (6) sets the value of the highest order among the orders-per-priority into an order register 19 and sets this value so that it is set to the lowest order when it is read out next. A task executing unit (20) reads out an address of the task to be executed next from the priority register (18) and order register (19), executes the task, and after the execution, updates the information in the matrix circuit 1 on the basis of a state of the task. A plurality of tasks can be switched at a high speed.

### BACKGROUND OF THE INVENTION

1. Field of the Invention

The invention relates to a task program control system and a task program control method for performing a program control in, for example, a network processor.

2. Related Background Arts

Hitherto, as a technique which is used in a network processor such that a process of a network control that is performed by hardware is executed by software, for example, there is a technique shown in “Lebel One (TM) IXP1200 Network Processor DataSheet”. Since such a processor for processing the network has register banks every four threads, contexts can be switched by switching the register banks. According to such a construction, since only four register banks exist, in the case where threads more than the four threads are executed, a retreat of the context is necessary and it is difficult to control a number of tasks.

As a method of reducing the number of cycles of a context switch of the tasks by dividing the tasks and polling them instead of using the context switch, for example, there is a method disclosed in JP-A-10-63517 “Real-time information process and its apparatus”.

The switching method by the register banks, however, is a method by the specific processor and cannot be realized by a general processor. Since the register banks correspond to the four threads, if tasks more than four tasks are executed in parallel, the problem of the retreat and recovery of the context occurs again.

The method disclosed in JP-A-10-63517 has problems such that a wasteful polling process in which the task has to be activated once within a predetermined time for the purpose of polling is necessary and the tasks have to be divided.

### SUMMARY OF THE INVENTION

It is, therefore, an object of the invention to provide a task program control system and a task program control method for performing a program control, for example, in a network processor.

To solve the above problems, the present invention is accomplished by the following aspects.

(Aspect 1)

There is provided a task program control system comprising: a storing circuit which stores information showing priorities of a plurality of tasks and orders-per -priority; a priority reading circuit which reads out the priority of the task of the highest priority from the storing circuit; an order reading circuit which reads out order-per-priority data of the priority read out by the priority reading circuit; a priority register which holds a value of the priority reading circuit; an order register which holds a value of the order in the priority read out by the priority reading circuit; an order-per-priority control circuit which sets a value of the highest order in the order-per-priority data read out by the order reading circuit into the order register and, when the value in the order register is read out, sets the read-out value so as to become the lowest order at such timing in the case where it is read out next; and a task executing unit which reads out the values in the priority register and the order register as an address of a task which is executed next, executes the task, and after the execution, updates the information in the storing circuit on the basis of a value which the task has and shows whether the task itself is continued or stopped.

<Aspect 2>

In a task program control system according to the aspect 1, when an address of an arbitrary task is read out from the priority register and the order register, information corresponding to the task in the storing circuit is cleared.

<Aspect 3>

In a task program control system according to the aspect 1 or 2, the system further comprises: a counter which counts a value of a read access from the task executing unit; a masking circuit which has a predetermined value corresponding to a specific priority and outputs a count value of the counter when the count value exceeds the predetermined value; and a specific priority reading circuit which, when the count value is outputted from the masking circuit, reads out the priority of the task of the highest priority among the priorities which are equal to and lower than the specific priority from the storing circuit.

<Aspect 4>

In a task program control system according to any one of the aspects 1 to 3, wherein a program table and a data table showing a program address and a data address corresponding to an arbitrary task are prepared, and when the address of the arbitrary task is read out from the priority register and the order register, the task executing unit executes the relevant task program on the basis of the addresses in the program table and the data table and the data is accessed.

<Aspect 5>

There is provided a task program control method comprising: a storing step of storing information showing priorities of a plurality of tasks and orders-per-priority into a memory; a priority reading step of reading out the priority of the task of the highest priority from the memory; an order reading step of reading out order-per-priority data of the priority read out by the priority reading step; a priority holding step of holding a value of the priority read out in the priority reading step into a priority register; an order holding step of holding a value of the order in the priority read out in the priority reading step into an order register; an order-per-priority control step of setting a value of the highest order in the order-per-priority data read out in the order reading step into the order register and, when the value in the order register is read out, setting the read-out value so as to become the lowest order at such timing in the case where it is read out next; and a task executing step of reading out the values in the priority register and the order register as an address of a task which is executed next, executing the task, and after the execution, updating the information in the memory on the basis of a value which the task has and shows whether the task itself is continued or stopped.

The above and other objects and features of the present invention will become apparent from the following detailed description and the appended claims with reference to the accompanying drawings.

### BRIEF DESCRIPTION OF THE DRAWINGS

FIG. 1 is a constructional diagram showing an embodiment 1 of a task program control system of the invention;

FIG. 2 is a whole constructional diagram of the embodiment 1 of the invention;

FIG. 3 is an explanatory diagram of an example of processes of a typical protocol sequence;

FIG. 4 is an explanatory diagram in which the processes of the protocol in FIG. 3 are expressed by functions;

FIGS. 5A and 5B are explanatory diagrams of a task program which is executed in the embodiment 1 of the invention;

FIGS. 6A and 6B are explanatory diagrams of processes of a main routine for calling a task;

FIGS. 7A and 7B are explanatory diagrams of an initial allocating situation of the tasks;

FIGS. 8A to 8C are explanatory diagrams of each task program;

FIG. 9 is an explanatory diagram showing an allocating state of a program table in a main memory;

FIG. 10 is an explanatory diagram showing an executing order of the tasks;

FIG. 11 is a whole constructional diagram of an embodiment 2;

FIG. 12 is a constructional diagram of a main section of a task scheduler in the embodiment 2;

FIG. 13 is a constructional diagram of a main section of a task scheduler in an embodiment 3;

FIG. 14 is an explanatory diagram showing an example of the operation in the embodiment 3;

FIG. 15 is a whole constructional diagram of an embodiment 4;

FIGS. 16A and 16B are explanatory diagrams of constructions of a program table and a data table in the embodiment 4;

FIGS. 17A and 17B are explanatory diagrams showing a structure of a task program which is executed in the embodiment 4;

FIGS. 18A and 18B are explanatory diagrams of processes of a main routine for calling a task; and

FIGS. 19A and 19B are explanatory diagrams showing examples of the program table and the data table in the embodiment 4.

### DETAILED DESCRIPTION OF THE PREFERRED EMBODIMENTS

Embodiments of the invention will now be described hereinbelow in detail.

The invention relates to a system for switching tasks at a high speed with respect to a task program which is used for reducing the number of cycles of a context switch and controlled in a state transition.

<<Embodiment 1>>

<Construction>

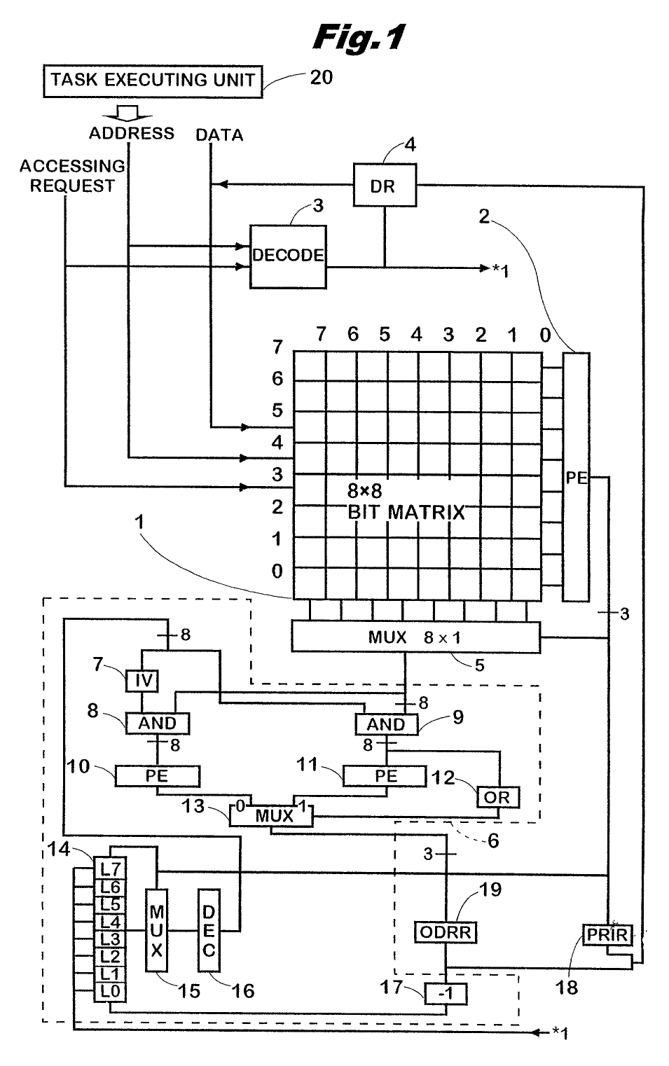

FIG. 1 is a constructional diagram showing an embodiment 1 of a task program control system of the invention. Prior to describing it, a fundamental control method of a task program will be explained.

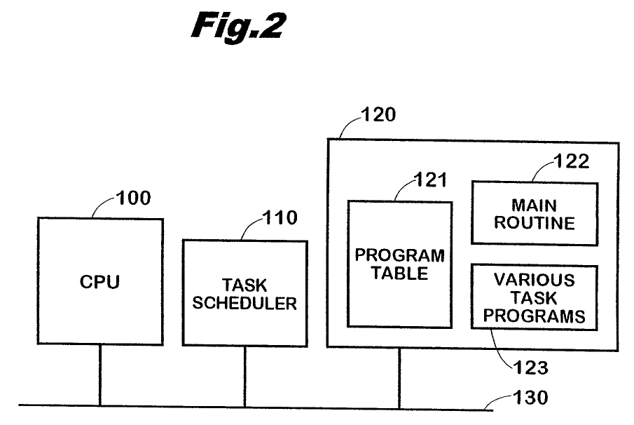

FIG. 2 is a whole constructional diagram of the embodiment 1 of the invention.

An apparatus shown in the diagram is constructed by a CPU 100, a task scheduler 110, a main memory 120, and a bus 130. The CPU 100 is a processor for executing various programs stored in the main memory 120 in accordance with a decision of the task scheduler 110. In the embodiment, a specific CPU is not presumed.

The task scheduler 110 is constructed by the circuits shown in FIG. 1 and has a function for forming a number of a task for allowing the CPU 100 to execute it next.

The main memory 120 is a memory which stores the various programs and data and is used as a work area of the CPU 100. A program table 121, a main routine 122, and various task programs 123 have been stored in the main memory 120. The program table 121, main routine 122, and various task programs 123 will be explained hereinlater.

The bus 130 is a system bus for connecting the CPU 100, task scheduler 110, and main memory 120.

A construction of the program of the task which is executed by the CPU 100 and a construction of the main routine 122 for activating the program will be first explained.

For example, a protocol process which is executed by a network is regarded as a following sequence even in processes of a lower layer other than a physical layer and can be executed.

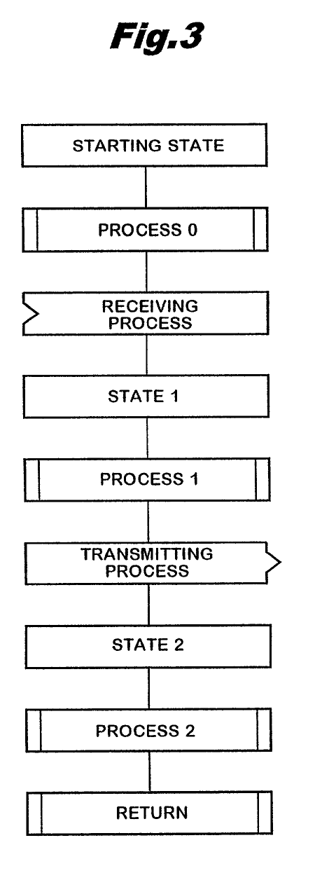

FIG. 3 is an explanatory diagram of an example of processes of a typical protocol sequence.

Although process contents of each sequence are simple in terms of the processes of the protocol, a complicated control can be performed by allowing the processes to be executed in parallel with the other sequence and executing them while communicating with each other.

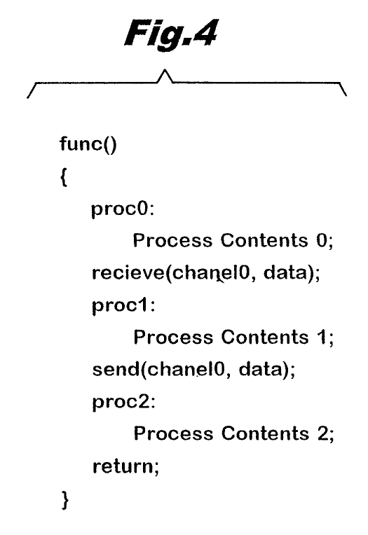

FIG. 4 is an explanatory diagram in which the processes of the protocol of FIG. 3 are expressed by functions.

In the diagram, each of “proc0” to “proc2” corresponds to a label of each process. “receive(channel0,data);” shows that data “data” is received from a communication path “channel0”. “send(channel0,data);” shows that the data “data” is transferred to a communication path “channel0”. “return;” shows that a state is set to a starting state.

In the sequence processes shown in FIG. 3, a receiving process and a transmitting process usually need the cycles of the numbers larger than the number of cycles which are necessary for processes closed only for such a sequence. This is because the execution is waited until a sequencer of the partner of the reception or transmission can be prepared. In this case, a control to execute another task is performed on a real-time OS.

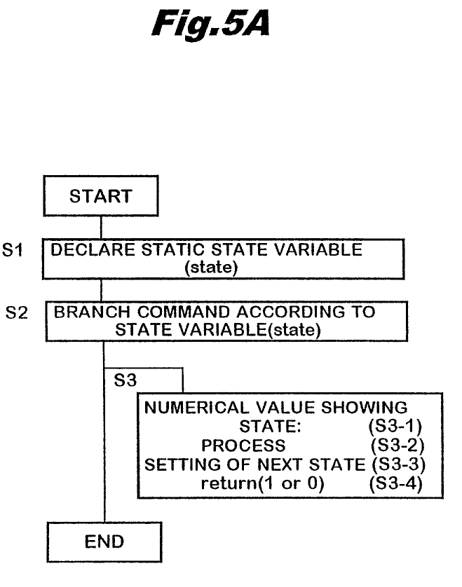

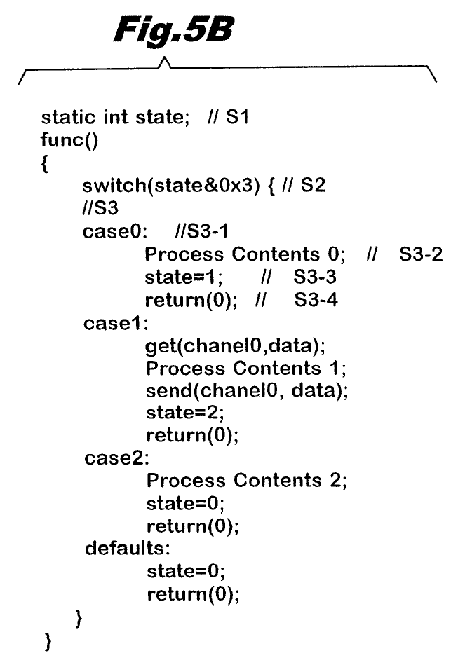

FIGS. 5A and 5B are explanatory diagrams of the task program which is executed in the embodiment 1 of the invention. FIG. 5A is a flowchart and FIG. 5B is a diagram in which contents of the flowchart are described by the C language.

The sequence processes having the state as shown in FIG. 3 can be rewritten to a branch command according to the state and a form of the next state setting.

Step S1 shows a variable for holding the state of the task.

Step S2 shows the branch command according to the state variable.

Step S3 shows process contents according to the state and its construction is divided into steps S3-1 to S3-4.

That is, step S3-1 shows a numerical value indicative of the state and the branch command in step S2 is branched by this value.

Step S3-2 shows the process according to the state.

Step S3-3 sets the state at the time when it is executed next.

Step S3-4 shows a return command and exits from the task. At this time, “1” is returned when it is reexecuted by the task scheduler 110 and “0” is returned when the state is in a waiting state or the process is finished.

In FIG. 5B, a comment (//) corresponds to step S** in FIG. 5A (** denotes an arbitrary numerical value).

“get(channel0,data)” in “case1:” in FIG. 5B corresponds to “receive(channel0,data)” in FIG. 4B. A difference is as follows. That is, “receive(channel0,data)” is waited until the “data” reaches the “channel0”. On the other hand, according to “get(channel0,data)”, it is sufficient to read the data “data” which has already existed in the “channel0” and no waiting state occurs. According to the construction in FIG. 5B, a waiting process is not clearly shown but the process is returned to the main routine 122 by “return(0)” in step S3-4.

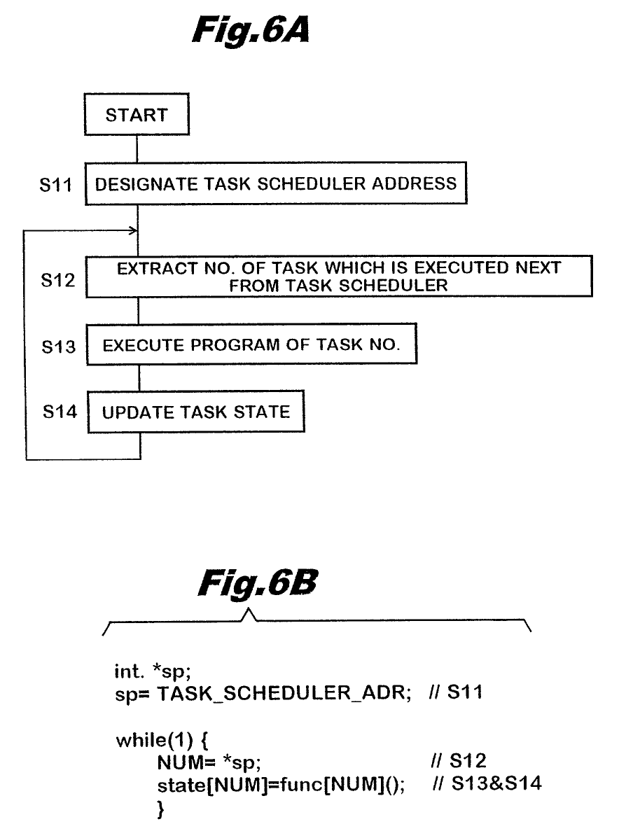

FIGS. 6A and 6B are explanatory diagrams of the processes of the main routine for calling the task. FIG. 6A is a flowchart and FIG. 6B is an explanatory diagram in which the processes of FIG. 6A are expressed by the C language.

First, in step S11, a task scheduler address (TASK_SCHEDULER_ADR in FIG. 6B) allocated to a specific address is set into a register (sp in FIG. 6B). Subsequently, in step S12, the number of the task (NUM in FIG. 6B) which is executed next is extracted from the task scheduler 110. The task scheduler 110 always forms the number of the task which is executed next.

In step S13, a program (func[NUM]( ) in FIG. 6B) of the task number is executed.

In step S14, a return value of the execution of the task program is reflected to a state (state[NUM] in FIG. 6B) corresponding to the task number.

The state of the task corresponds to a bit matrix in the task scheduler 110, which will be explained hereinlater. The task number corresponds to an address in the bit matrix. Steps S12 to S14 are executed by an infinite loop.

A construction of the task scheduler 110 shown in FIG. 1 will now be described.

The system shown in FIG. 1 comprises: a matrix circuit 1 as a storing circuit; a priority encoder (PE) 2 as a priority reading circuit; a decoder (DECODE) 3; a driver (DR) 4; a multiplexer (MUX) 5 as an order reading circuit; an order-per-priority control circuit 6 (an inverter (IV) 7, AND circuits 8 and 9, priority encoders (PE) 10 and 11, an OR circuit 12, a multiplexer (MUX) 13, an order-per-priority register 14, a multiplexer (MUX) 15, a decoder (DEC) 16, a subtractor 17); a priority register (PRIR) 18; an order register (ODRR) 19; and a task executing unit 20.

The matrix circuit 1 is an (8×8) bit matrix. The vertical direction in the diagram indicates the priority and the lateral direction indicates the order in this priority. The upper priority is higher and the order on the left side in the same priority is higher. In the embodiment, there are eight kinds of priorities and there are eight kinds of orders in each priority. The invention is not limited to the number of priorities and the number of orders as mentioned above. The matrix circuit 1 has a state of one bit every task. “0” indicates a waiting state or a pause state and “1” indicates an executable state. The task allocated to the bit in the executable state in which 15 the number of priorities is large and the order in the same priority is high is executed by the CPU 100.

The priority encoder 2 has a function for getting the OR of the bits in the executable state every priority, priority-encoding the OR, and detecting the highest priority in the executable state. An output consists of three bits. If bit is set to “1” in the line of the priority 7, the output becomes 111. If no bit is set to “1” in every line of every priority, the output becomes 000.

The decoder 3 has a function to form a drive signal for outputting the data in the priority register 18 and order register 19 to the data bus in response to an accessing request and an address from the CPU 100. The drive signal is used also to update the value in the order-per-priority register 14. The driver 4 is a driver to the data bus.

The multiplexer 5 is a multiplexer to extract a line bit (order-per-priority data) of the priority designated by the priority encoder 2 from the matrix circuit 1.

The order-per-priority control circuit 6 has functions for setting the value of the highest order into the order register. 19 in the order-perpriority data read out by the multiplexer 5 and, when the value in the order register 19 is read out, setting the read-out value so as to become the lowest order at such timing when it is read out next. The control circuit 6 is constructed by the inverter 7 to the subtractor 17.

The inverter 7 is a circuit for inverting an output of the decoder 16. the AND circuit 8 is a circuit for getting the AND of the output of the decoder 16 inverted by the inverter 7 and the output of the multiplexer 5. The AND circuit 9 is a circuit to get the AND of the output of the decoder 16 and the output of the multiplexer 5.

The priority encoders 10 and 11 are priority encoders for priority-encoding outputs of the AND circuits 8 and 9 and obtaining the bit of the highest order, respectively. That is, the priority encoder 10 is a priority encoder for obtaining the bit of the highest order in the mask portion of the bit based on a mask signal which is outputted from the decoder 16. The priority encoder 11 is a priority encoder for obtaining the bit of the highest order in the portion which is not masked.

The OR circuit 12 is a circuit to get the OR of the output of the AND circuit 9. If at least one of bits is set to “1” in the output of the AND circuit 9, “1” is outputted. The multiplexer 13 is a multiplexer for selecting one of outputs from the two priority encoders 10 and 11. That is, the priority encoder output corresponding to the input which is not masked is always preferentially selected.

The order-per-priority register 14 is a circuit for holding the order when the task at the level is switched to the waiting state every priority. As mentioned above, the holding timing is set to the timing when the drive signal from the decoder 3 is asserted. The multiplexer 15 is a multiplexer for selecting the output from the order-per-priority register 14 in accordance with the output of the priority encoder 2. The decoder 16 is a decoder for decoding the output of the multiplexer 15 from 3 bits to 8 bits. That is, the decoder 16 generates a mask signal based on the order held in the order-per-priority register 14. The subtractor 17 is a subtractor for decreasing the value in the order register 19 by “1”.

The priority register 18 is a register for holding the priority of the matrix circuit 1 as an output of the priority encoder 2. The order register 19 is a register for holding the values of the orders-per-priority as an output of the multiplexer 13.

The task executing unit 20 is a function which is realized when 15 the CPU 100 executes the main routine 122. The task executing unit 20 reads out the values in the priority register 18 and order register 19 as an address of the task which is executed next, executes the task, and after the execution, updates the information in the matrix circuit 1 on the basis of the value which the task has and indicates whether the task itself is continued or stopped.

<Operation>

As an example of the operation, a state where three task programs operate is shown and the task program in FIGS. 5A and 5B, the main routine in FIGS. 6A and 6B, and the operation of FIG. 1 will be described.

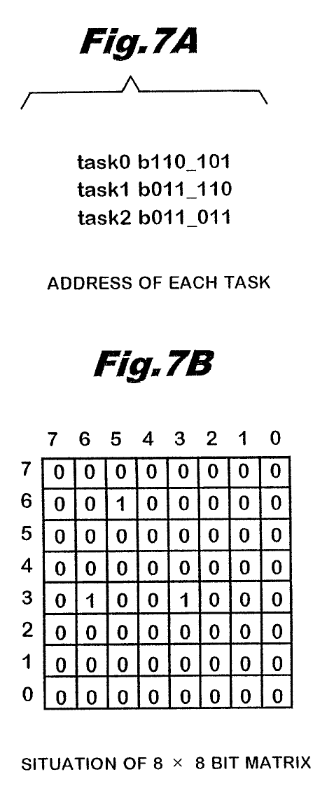

FIGS. 7A and 7B are explanatory diagrams of an initial allocating situation of the tasks.

FIG. 7A shows an address of each task. As shown in the diagram, the address of each task is shown by a numerical value of 6 bits. First character “b” is a symbol showing that the address is expressed by a binary indication. An underscore provided at an intermediate position of “0” or “1” of 6 bits is an indication such that the priority and the orders-per-priority can be distinguished and has no substantial meaning.

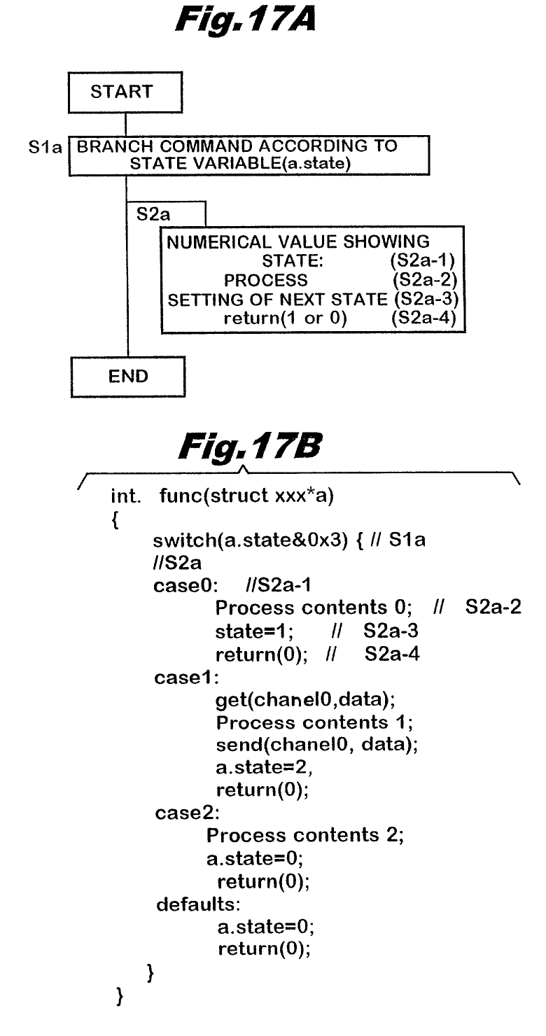

FIG. 17B shows a bit state in the matrix circuit 1. For example, “task0” has an address “b110_{—}101” and “1” is set at the position corresponding to the 6th row and the 5th column on the (8×8) bit matrix. Similarly, “task1” has an address “b011_{—}110” and “1” is set at the position corresponding to (3rd row, 6th column) on the (8×8) bit matrix. “task2” has an address “b011_{—}011” and “1” is set at the position corresponding to (3rd row, 3rd column) on the (8×8) bit matrix. They are set by the initial setting before the main routine program shown in FIG. 6B is executed. In the matrix circuit 1, “b000-000” has been reserved.

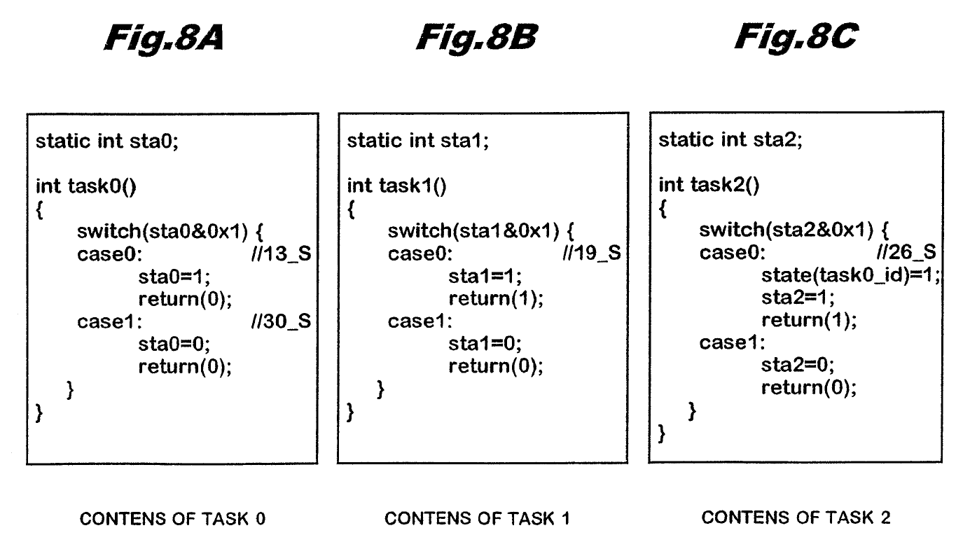

FIGS. 8A to 8C are explanatory diagrams of the task programs. FIG. 8A shows the program of “task0”. FIG. 8B shows the program of “task1”. FIG. 8C shows the program of “task2”.

A control structure of each task program is similar to that of FIG. 5B.

The operations of the task scheduler 110 and the three task programs will now be described. To distinguish the description of the hardware from that of the software, it is assumed that a procedure of the hardware is shown by step **_H and a procedure of the software is shown by step **_S (** denotes an arbitrary numerical value).

[Step 1_H]

The priority encoder 2 extracts the data from the matrix circuit 1. As shown in FIGS. 7A and 7B, since the maximum line on which “1” has been set is the 6th row, 6 (=b110) is outputted.

[Step 2_H]

The bit train of the 6th row is selected from the matrix circuit 1 by the multiplexer 5 in accordance with the output of the priority encoder 2.

[Step 3_H]

The order-per-priority of the 6th row is extracted from the order-per-priority register 14 by the multiplexer 15. Ordinarily, the order-per-priority is equal to b111 in the initial state. b111 indicates 7 of a decimal notation and shows that the priority is the highest in the embodiment.

[Step 4_H]

The decoder 16 decodes the pattern corresponding to b111 (=7) into b11111111 of 8 bits. It is assumed that the decoding is performed such that, for example, b000 (=0) is decoded into b00000001 and b001 (=1) is decoded into b00000011.

[Step 5_H]

The AND of the decoded data and the data outputted from the multiplexer 5 is got by each of the AND circuits 8 and 9. The AND circuit 8 gets the AND of the decoded data and the data inverted by the inverter 7. That is, the AND circuit 8 gets the AND of the data (b00000000) in which all bits have been masked and the data of the multiplexer 5. The AND circuit 9 gets the AND of the data (b11111111) in which all bits are not masked and the data of the multiplexer 5. Thus, the output of the AND circuit 8 becomes b00000000 and the output of the AND circuit 9 becomes b00100000.

[Step 6_H]

The outputs of the priority encoders 10 and 11 are b000 and b101 through the outputs of the AND circuits 8 and 9. It is determined in the OR circuit 12 that one of the bits in the output of the AND circuit 9 is equal to 1.

[Step 7_H]

The output of either the priority encoder 10 or 11 is selected by the multiplexer 13 in accordance with the value of the OR circuit 12. Since the output of the OR circuit 12 is equal to 1, the output of the priority encoder 11 is selected and the output is b101.

[Step 8+L_H]

From the above result, b110 and b101 are inputted into the priority register 18 and order register 19, respectively. This means that the address value of “task0” is separated into upper bits and lower bits and inserted.

[Step 9_S]

After the initial setting, the CPU 100 sets a task scheduler address into a register (not shown) in (S11) in FIG. 6B. The processing routine enters the infinite loop and the data obtained in step 8_H is extracted from the task scheduler 110 in (S12).

[Step 10_H]

The decoder 3 decodes a read access in step 9_S and the values in the priority register 18 and order register 19 are outputted onto the data bus through the driver 4.

[Step 11_H]

Since the drive signal from the decoder 3 also serves as a setting signal of the order-per-priority register 14, the data b100 obtained by subtracting “1” from the value in the order register 19 is set into a register L6 corresponding to the level, that is, the priority 6 here of the priority register 18.

[Step 12_S]

The data read out by the main routine in FIG. 6B is set into a variable “NUM”. A function of an array corresponding to the “NUM” is executed ((S13) in FIG. 6B and step S13 in FIG. 6A).

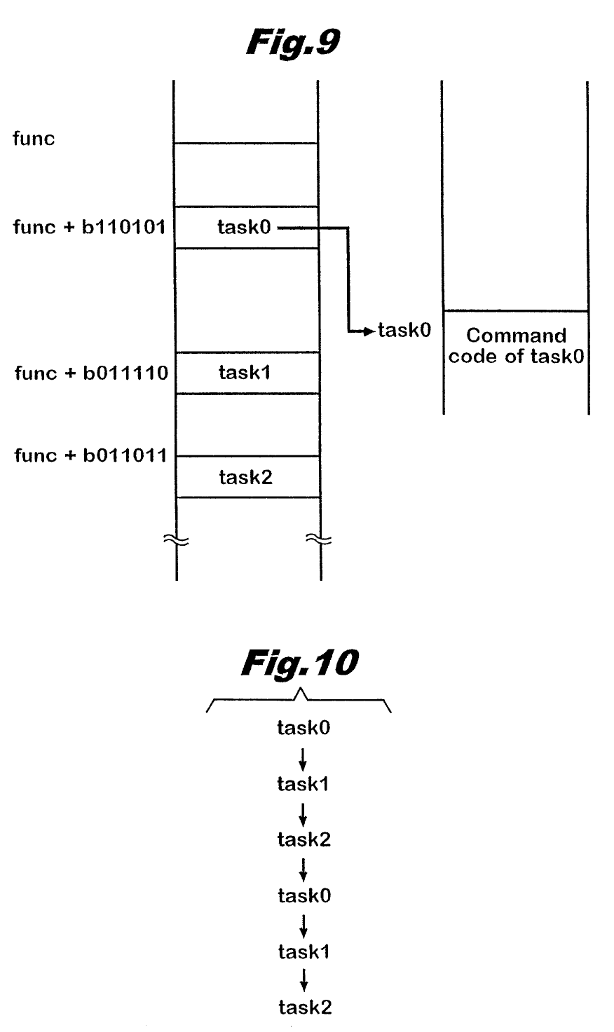

FIG. 9 is an explanatory diagram showing an allocating state of the program table 121 in the main memory 120.

As shown in the diagram, an array “func” is allocated as a program table into the memory, and execution start addresses of “task0”, “task1”, and “task2” have been allocated to addresses corresponding to the numbers of “task0”, “task1”, and “task2”. Therefore, this means that the task is branched to the “task0” address and executed in (S13) in FIG. 6A.

[Step 13_S]

“task0” in FIG. 8A is executed and since the value of a state variable “sta0” is equal to 0 as an initial value, a command corresponding to “case0” is executed (//13_S in FIGS. 8A to 8C). It is updated to the state variable 1 (sta0=1) in this portion. Further, 0 is returned (return(0)).

[Step 14_S]

In FIG. 6B, 0 is written into the return value at a location corresponding the “NUM” address of the array “state”. The array “state” corresponds to the rows and columns of the (×8) bit matrix of the matrix circuit 1. Therefore, the bit corresponding to NUM (=b110_{—}101) in the matrix circuit 1 is cleared to “0”.

[Step 15_H]

Since the bit at the 6th row and the 5th column of the matrix circuit 1 is cleared, there are only two bits of the 3rd row where “1” has been set. Therefore, the output of the priority encoder 2 is equal to 3. Thus, the multiplexer 5 extracts the bit train of the 3rd row. Since all of the initial values of the order-per-priority register 14 are b111 (=7), in a manner similar to steps 4_H to 8_H mentioned above, b011 and b110 as an address of “task1” are inputted into the priority register 18 and order register 19, respectively.

[Step 16_S]

The number of the task to be executed next is extracted again from the task scheduler 110 by the infinite loop of the main routine (step S12 and //(S12) in FIGS. 6A and 6B).

[Step 17_H]

Together with the reading operation from the task scheduler 110, a value 101 obtained by decreasing “1” from the value in the order register 19 is inputted into the register corresponding to the priority 3 in the order-per-priority register 14. b011110 is outputted onto the data bus.

[Step 18_S]

In FIG. 6B, b011110 is set into “NUM” and “task1” corresponding to address b011110 is executed from the array “func” of the function (step S13 and //(S13) in FIGS. 6A and 6B).

[Step 19_S]

“task1” shown in FIG. 8B is executed and since the value of a state variable “sta1” is equal to 0 as an initial value, a command corresponding to “case0” is executed (//19_S in FIG. 8B). The state variable is updated to 1 in this portion (sta1=1). Further, “1” is returned (return(1)).

[Step 20_S]

In FIG. 6B, “1” is written into the return value at a location corresponding to the “NUM” address of the array “state”. The array “state” corresponds to the rows and columns of the matrix circuit 1. Therefore, the bit corresponding to NUM (=b011_{—}101) in the matrix circuit 1 is reset to “1”.

[Step 21_H]

Since the bit at the 6th row and the 5th column of the matrix circuit 1 is cleared, there are only two bits of the 3rd row where “1” has been set. Therefore, the output of the priority encoder 2 is equal to 3. Thus, the multiplexer 5 extracts the bit train of the 3rd row. Since the register corresponding to the priority 3 in the order-per-priority register 14 has been updated to 101, b00111111 is outputted to the decoder 16.

[Step 22_H]

When each of the AND circuits 8 and 9 gets the AND of the output b00111111 of the decoder 16 and the output b01001000 of the multiplexer 5, b01000000 and b00001000 are outputted, respectively. Since the output of the OR circuit 12 is equal to 1, the output of the priority encoder 11 which receives the output of the AND circuit 9 is selected and b011 is inputted into the order register 19.

In such a construction as mentioned above, when the task which was once executed is executed next, it is executed last in the same priority. That is, after the task of the order of the 6th bit is executed, the value in the order-per-priority register 14 is equal to b101 (=5), and the mask signal in which the data of bits 6 and 7 is masked is outputted from the decoder 16. Thus, although the value of the priority encoder 10 is equal to b110 and the value of the priority encoder 11 is equal to boll, since “1” has been set in the output of the AND circuit 9, the output of the priority encoder 11 is selected.

[Step 23_S]

The number of the task to be executed next is extracted again from the task scheduler 110 by the infinite loop of the main routine (step S12 and //(S12) in FIGS. 6A and 6B).

[Step 24_H]

Together with the reading operation from the task scheduler 110, the value 010 obtained by decreasing “1” from the value in the order register 19 is inputted into the register corresponding to the priority 3 in the order-per-priority register 14. b011011 is outputted onto the data bus.

[Step 25_S]

In FIG. 6B, b011011 is set into “NUM” and “task2” corresponding to address b011011 is executed from the array “func” of the function (step S13 and //(S13) in FIGS. 6A and 6B).

[Step 26_S]

“task2” shown in FIG. 8C is executed and since a value of a state variable “sta2” is equal to 0 as an initial value, the command corresponding to “case0” is executed. “task0_id” in “state[task0_id]” corresponds to address b110101 of “task0” and the operation such that “1” is written corresponds to the operation such that “1” is written into b110 (=6) row and b101 (=5) column Of the matrix circuit 1.

The state variable is updated to 1 in the portion of //26_S in FIG. 8C (sta2=1). Further, “1” is returned (return (1)).

[Step 27_S]

In FIG. 6B, “1” is written into the return value at the location corresponding to the “NUM” address of the array “state”. The array “state” corresponds to the rows and columns of the matrix circuit 1. Therefore, the bit corresponding to NUM (=b011_{—}011) in the matrix circuit 1 is reset to “1”.

[Step 28_H]

Since “1” has been set in the 6th row of the matrix circuit 1, the priority encoder 2 extracts the data. As shown in FIGS. 7A and 7B, since the maximum line in which “1” has been set is the 6th row, 6 is outputted. After that, the same processes as those in steps 4_H to 8_H mentioned above are executed.

[Step 29_S]

The number of the task to be executed next is extracted again from the task scheduler 110 by the infinite loop shown in the main routine in FIG. 6B (step S12 and //(S12) in FIGS. 6A and 6B). b110101 is set into “NUM” and “task0” corresponding to the address b110101 is executed from the array “func” of the function (step S13 and //(S13) in FIGS. 6A and 6B).

[Step 30_S]

Since the state variable “sta0” in FIG. 8A is equal to 1, the commands of “case1” and subsequent cases are executed. The state variable “sta0” is set to 0 and 0 is returned (return(0)).

[Step 31_H]

Since the bit at the 6th row and the 5th column of the matrix circuit 1 is cleared, there are only two bits of the 3rd row where “1” has been set. Therefore, the output of the priority encoder 2 is equal to 3. Thus, the multiplexer 5 extracts the bit train of the 3rd row. Since the register value of the priority 3 in the order-per-pricrity register 14 is equal to b010 (=2), the outputs of the AND circuits 8 and 9 are b10010000 and b00000000, respectively. Therefore, the output of the OR circuit 12 is equal to 0 and the output of the multiplexer 13 is the output b110 of the priority encoder 10. It corresponds to lower bits of the address of “task1”. Therefore, “task1” is executed.

[Step 32_S]

After that, “task1” is activated and “task2” is subsequently 20 activated.

FIG. 10 is an explanatory diagram showing an executing order of such tasks.

As mentioned above, the tasks are alternately executed in accordance with the bit designation of the priority of the matrix circuit 1. Since the scheduling portion is executed by the hardware and the execution activating portion is executed by the software, the invention can be applied to every CPU 100.

<Effects>

As mentioned above, according to the embodiment 1, the task scheduler 110 comprising the matrix circuit 1, order-per-priority control circuit 6, and the like determines the task which is executed next. Each task has information showing whether the task itself is continued or stopped. If the task is executed, the state of the matrix circuit 1 is updated on the basis of this information. Therefore, the task switching can be performed at a high speed. For example, the program of the C language and the branch portion to the state label of each task shown in the embodiment are equal to about five commands as an assembler program, respectively. Therefore, the program can be shifted from the task program which is being executed to the task program of the next highest priority within 20 cycles even in consideration of a loss due to the data access and the branch command. In the general processor, when considering the fact that the context switch needs at least about 100 cycles, the processing method of an extremely high speed can be provided.

The embodiment is not limited to the structure of the CPU 100 but can be also applied to any CPU or DSP.

<<Embodiment 2>>

<Construction>

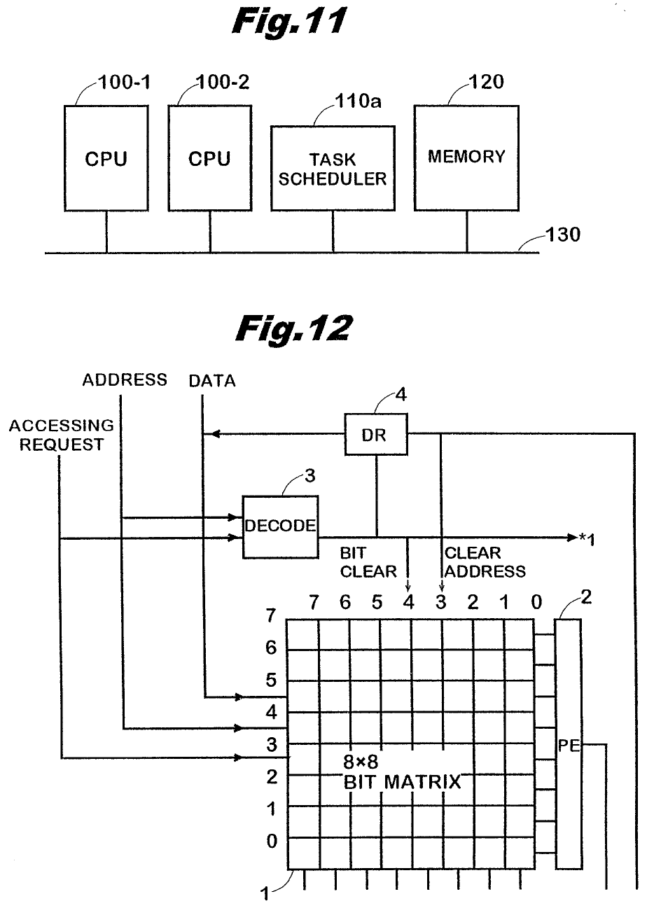

FIG. 11 is a whole constructional diagram of the embodiment 2.

Although one CPU 100 exists in the above embodiment 1, in the embodiment 2, a plurality of CPUs 100 (100-1, 100-2) are connected onto the same bus 130. A task scheduler 110a in the diagram is constructed as follows.

FIG. 12 is a constructional diagram of a main section of the task scheduler 110a in the embodiment 2.

Although its fundamental construction is similar to that of the embodiment 1, the bits are cleared on the basis of the address data by a control signal for reading the task scheduler 110a, that is, reading the priority register 18 and order register 19 (they are not shown in FIG. 12). Since other constructions are similar to those shown in FIG. 1, their description is omitted here.

<Operation>

Explanation will now be made by using the example of the task of the embodiment 1.

First, when the CPU 100-1 obtains a bus right and accesses to the task scheduler 110a, the address value of “task0” is obtained in a manner similar to the embodiment 1. The CPU 100-1 executes “task0” as it is. In the embodiment 2, when the values in the priority register 18 and order register 19 are read out, the bits corresponding to the address value of “task0” are cleared at the same time.

Now, assuming that the CPU 100-2 accesses to the task scheduler 110a while the CPU 100-1 is executing “task0”, since the bits of “task0” have been cleared, the address value of “task1” is read out and “task1” is executed.

As mentioned above, each time the task address corresponding to the task of the highest priority is read out, by clearing the bits corresponding to the task address in the matrix circuit 1, a situation such that a plurality of CPUs 100 execute the same task is eliminated. Even if a plurality of CPUs 100 are used, the different task can be executed every order-per-priority.

<Effects>

According to the embodiment 2 as mentioned above, if the address of an arbitrary task is read out, the address value of this task in the matrix circuit 1 is cleared. Therefore, even if a plurality of CPUs exist, the task can be executed without overlapping.

<<Embodiment 3>>

Among a plurality of tasks, if many tasks of high priorities are allocated, a situation such that the tasks of low priorities are not executed occurs. Such a situation also occurs on the general real-time OS. To solve it, in the embodiment 3, even the tasks of the low priorities can be executed at a low period.

<Construction>

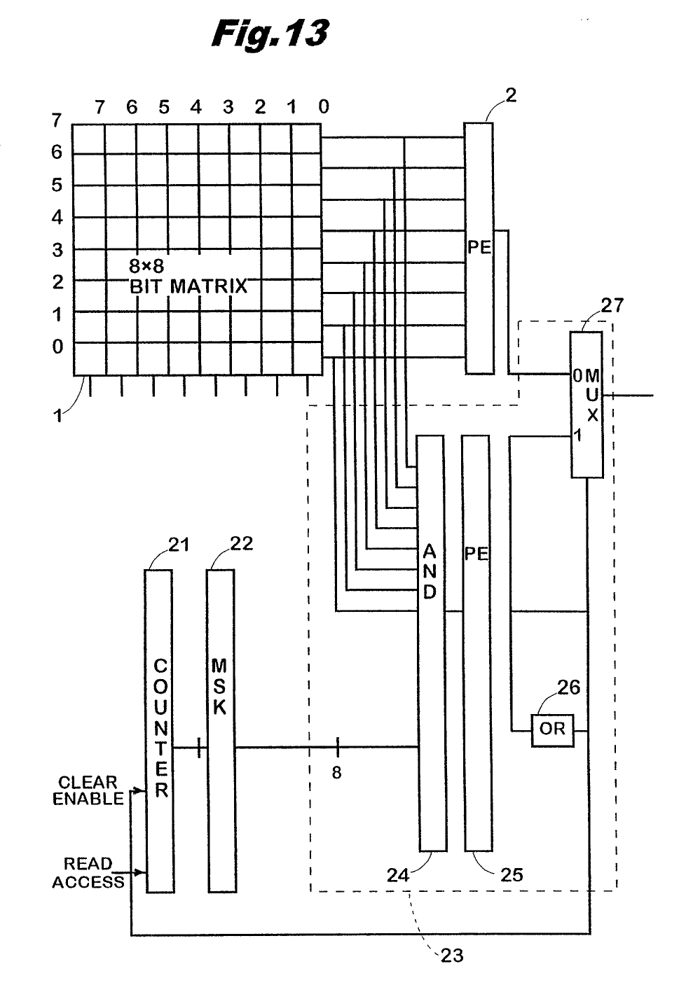

FIG. 13 is a constructional diagram of a main section of a task scheduler in the embodiment 3.

In the diagram, portions different from the embodiment 1 are shown and the matrix circuit 1 and priority encoder 2 are similar to those in the embodiment 1. In the embodiment 3, and a counter (COUNTER) 21, a masking circuit (MSK) 22, a specific priority reading circuit 23 (an AND circuit 24, a priority encoder 25, an OR circuit 26, and a multiplexer 27) are further added. Since other constructions are similar to those of the embodiment 1, they are not shown and their explanations are omitted here.

The counter 21 is a counter which is counted up by the read access. When an output of the OR circuit 26 is equal to “1” and the read access is performed, the bit is cleared to “0”. In this example, it is assumed that a count value increases from upward toward downward of the diagram. The masking circuit 22 is a masking circuit for masking only a range of certain bits in an output of the counter 21. That is, the counter 21 has a 25 predetermined value corresponding to a specific priority and when the value of the counter 21 exceeds the predetermined value, the counter outputs the count value. That is, since a possibility that the task of a high priority which is executed is relatively high, the masking circuit is provided to mask it, thereby enabling the tasks of low priorities to be executed. The specific priority reading circuit 23 has a function such that when the count value is outputted from the masking circuit 22, the priority of the task of the highest priority among the specific priorities is read out from the matrix circuit 1. The circuit 23 is constructed by the AND circuit 24 to the multiplexer 27.

The AND circuit 24 is an AND circuit for getting the AND of the priority output of the matrix circuit 1 and an output of the masking circuit 22. The priority encoder 25 extracts the highest priority in an output of the AND circuit 24 and outputs a signal of 3 bits similar to that of the priority encoder 2 to the OR circuit 26 and multiplexer 27. The OR circuit 26 is an OR circuit for discriminating whether the bits of “1” exist in an output of the priority encoder 25 or not, and outputting “1” if YES. An output of the OR circuit 26 is connected to “clear enable” of the counter 21. The multiplexer 27 is a selector for selecting either the output of the priority encoder 2 or the output of the priority encoder 25. When the output of the OR circuit 26 is equal to “1”, the output of the priority encoder 25 is selected.

Although not shown, an output of the multiplexer 27 is supplied to the multiplexer 5 in the embodiment 3 and the orders-per-priority are read out on the basis of this output.

<Operation>

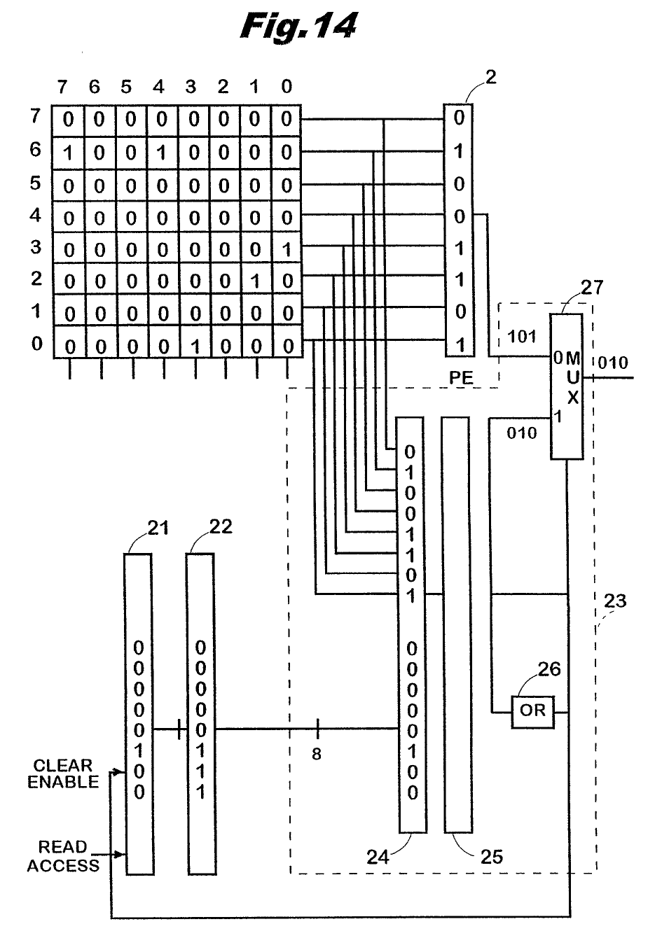

FIG. 14 is an explanatory diagram showing an example of the operation.

It is assumed that the bits have been allocated to the matrix circuit 1 as shown in the diagram. It is assumed that only the tasks allocated to the 6th row are executed and the tasks allocated to the 2nd row have not been executed.

In such a state, the output of the priority encoder 2 is equal to 6. It is now assumed that the value of the counter 21 is equal to b00100000 (in the diagram, upper bits correspond to the 0th row of the bit matrix of the matrix circuit 1 and lower bits correspond to the 7th row). In the masking circuit 22, it is assumed that only three upper bits are set to “1” and other lower bits are set so as to be masked to “0”. Therefore, the output of the masking circuit 22 is equal to b00100000.

The AND circuit 24 gets the AND of the bit output b10110010 of the matrix circuit 1 and the output b00100000 of the masking circuit 22 and outputs b00100000. Thus, the priority encoder 25 outputs b010 (=2). Thus, the output of the OR circuit 26 is equal to “1” and the multiplexer 27 selects the output b010 of the priority encoder 25 and outputs.

That is, when the read access is performed to the counter 21 64 times, the task of the priority 2 is preferentially activated. Upon reading of the next task, the counter 21 is cleared by the output of the OR circuit 26.

Although the embodiment has been described with respect to the case of preferentially activating the task of the priority 2, the task of another arbitrary priority can be also activated by setting the mask bits of the masking circuit 22.

<Effects>

According to the embodiment 3 as mentioned above, there are provided: the counter 21 which counts the value of the read access; the masking circuit 22 which masks the output of the counter 21 by the value corresponding to the specific priority; and the specific priority reading circuit 23 which, when the count output is equal to the count value corresponding to the specific priority, reads out the highest priority below the specific priority from the matrix circuit 1. Therefore, in addition to the effects of the embodiment 1, there is an effect such that since the tasks allocated to the levels of low priorities are periodically selected, even the task of the low priority can be activated.

<<Embodiment 4>>

In the embodiment 4, although the data construction is substantially the same, a higher effect will be obtained in case of executing the same processes to the different data. For example, as such an example, there is a process of the ATM cell data. The embodiment 4 mainly relates to a construction of software.

<Construction>

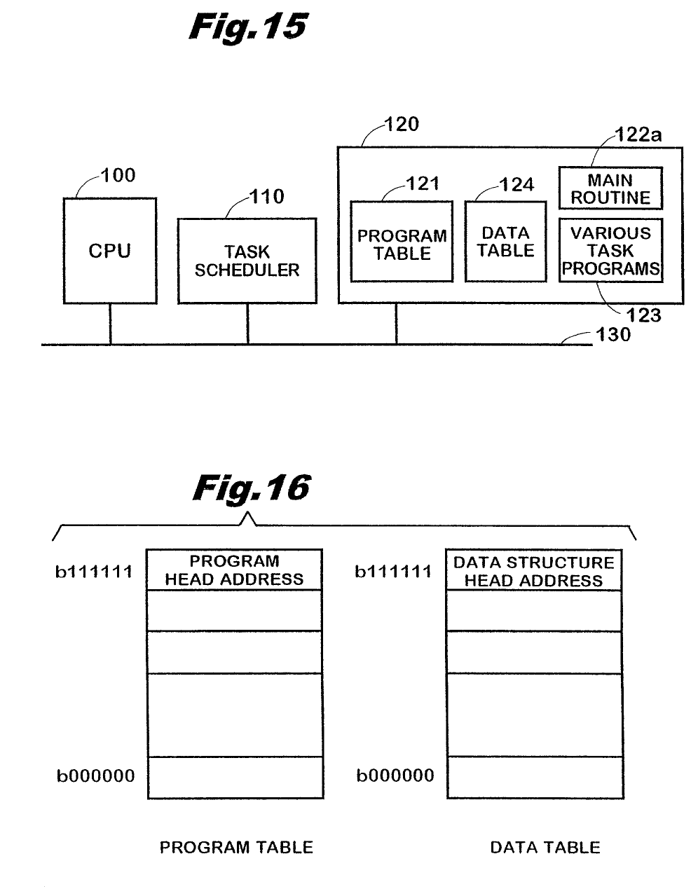

FIG. 15 is a whole constructional diagram of the embodiment 4.

According to an apparatus shown in the diagram, a construction in the main memory 120 differs from that of the specific examples 1 and 2. In addition to the program table 121, a data table 124 is provided in the main memory 120. The apparatus has a main routine 122a and the various task programs 123.

FIGS. 16A and 16B are explanatory diagrams of constructions of the program table 121 and data table 124.

As also shown in the description of the embodiment 1, the task scheduler 110 sends the number of the task to be executed next to the CPU 100. The CPU 100 accesses a program head address which is branched from the program table 121 in the main memory 120 and branches to this address, thereby executing the relevant task.

Similarly, the data table 124 is accessed from the number of the task to be executed next and the data is processed. In the program table 121 shown in FIG. 16A, the program head address has been set to the address corresponding to the task number which can be taken by the task scheduler 110. In the data table 124 shown in FIG. 16B, the data has been set into the table by a similar address allocation.

Thus, in the main routine 122a for realizing the function of the task executing unit 20, when a specific task number is read out from the matrix circuit 1, the program is executed and the data is accessed on the basis of the addresses in the program table 121 and data table 124. Since other constructions are similar to those in the embodiment 1, their description is omitted here.

<Operation>

FIGS. 17A and 17B are explanatory diagrams showing a structure of a task program which is executed in the embodiment 4. FIG. 17A is a flowchart and FIG. 17B is an explanatory diagram in which contents of the flowcharts are described by the C language.

A difference between the task program in the embodiment 4 shown in FIGS. 17A and 17B and the task program in the embodiment 1 shown in FIGS. 5A and 5B is that the declaration of the state variable (step S1 in FIG. 5A) does not exist in the task program in the embodiment 4. This is because the state variable becomes one element of the data which is sent as an argument of the function.

A difference between the program example of FIG. 17B and the program example of FIG. 5B is that the address value (struct xxx*a) in the data table 124 is sent as an argument of the function and the state variable is held as one element (a.state) of the data structure. “struct xxx*a” denotes an 25 address value of a variable “a” having a structure of xxx. As an updating of the state variable, the updating of one element of the data structure is shown by (a.state=).

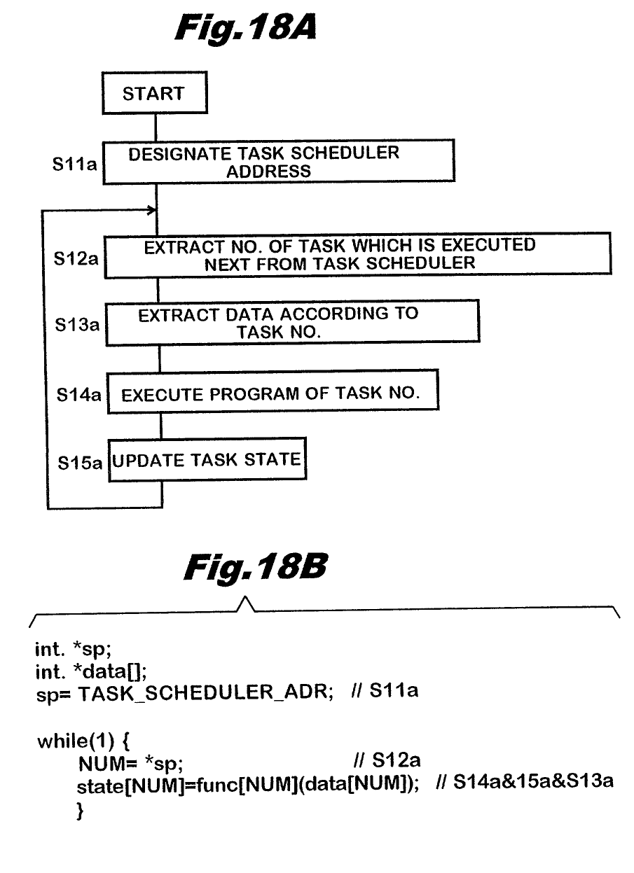

FIGS. 18A and 18B are explanatory diagrams of the main routine processes for calling the task. FIG. 18A is a flowchart and FIG. 18B is an explanatory diagram in which the processes are shown by the C language.

A difference between FIGS. 18A and 6A is that an extracting process of the data corresponding to the task number in step S13a, that is, a process for extracting the data address corresponding to the task number from the data table 124 is merely added. Other steps S11a, S12a, S14a, and S15a are the processes similar to those in steps S11, S12, and S14 in FIG. 6A.

A difference between the program example of FIG. 18B and the program example of FIG. 6B is merely that *data[NUM] exists in the argument of the array function “func”. It corresponds to a process for extracting the data address of the task number “NUM” from an array “data[ ]” of the data table 124.

By separating the program table 121 and data table 124 with respect to such a task number as mentioned above, in the different task numbers, the process to the different data can be performed by the same program.

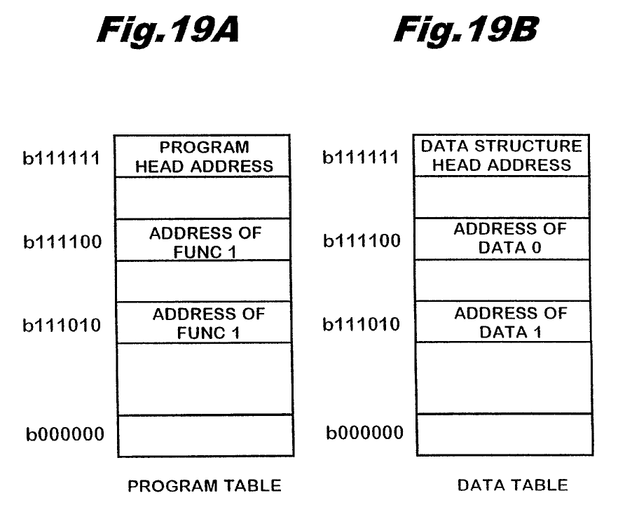

FIGS. 19A and 19B are explanatory diagrams showing an example of the program table 121 and data table 124 in case of executing such a process.

As shown in the diagrams, in the different task numbers (b111100 and b111010), the process to the different data (data0, data1) can be performed by the same program (fund).

<Effects>

As mentioned above, according to the embodiment 4, the program table 121 and data table 124 showing the program address and data address corresponding to an arbitrary task number are provided and when the specific task number is read out from the matrix circuit 1, the task program is executed on the basis of the addresses shown in those tables and the data access is performed. Therefore, for example, although they have the same data construction, if the same process is executed to the different data, there is no need to set the program for each data and it is sufficient to use a small program. It is particularly effective to a program like an object oriented program in which the data and the program have one structure.

The present invention is not limited to the foregoing embodiments but many modifications and variations are possible within the spirit and scope of the appended claims of the invention.

What is claimed is:

1. A task program control system comprising:
a storing circuit which stores information showing priorities of a plurality of tasks and orders-per-priority;
a priority reading circuit which reads out the priority of the task of the highest priority from said storing circuit;
an order reading circuit which reads out order-per-priority data of the priority read out by said priority reading circuit;
a priority register which holds a value of said priority reading circuit;
an order register which holds a value of the order in the priority read out by said priority reading circuit;
an order-per-priority control circuit which sets a value of the highest order in said order-per-priority data read out by said order reading circuit into said order register and, when the value in said order register is read out, sets said read-out value so as to become the lowest order at such timing in the case where it is read out next; and
a task executing unit which reads out the values in said priority register and said order register as an address of a task which is executed next, executes said task, and after the execution, updates the information in said storing circuit on the basis of a value which said task has and shows whether the task itself is continued or stopped.

2. A system according to claim 1, wherein when the address of an arbitrary task is read out from said priority register and said order register, the information corresponding to said task in said storing circuit is cleared.

3. A system according to claim 1, further comprises:
a counter which counts a value of a read access from said task executing unit;
a masking circuit which has a predetermined value corresponding to a specific priority and outputs a count value of said counter when the count value exceeds said predetermined value; and
a specific priority reading circuit which, when the count value is outputted from said masking circuit, reads out the priority of the task of the highest priority among the priorities which are equal to and lower than said specific priority from said storing circuit.

4. A system according to claim 2, further comprises:
a counter which counts a value of a read access from said task executing unit;
a masking circuit which has a predetermined value corresponding to a specific priority and outputs a count value of said counter when the count value exceeds said predetermined value; and
a specific priority reading circuit which, when the count value is outputted from said masking circuit, reads out the priority of the task of the highest priority among the priorities which are equal to and lower than said specific priority from said storing circuit.

5. A system according to claim 1, wherein
a program table and a data table showing a program address and a data address corresponding to an arbitrary task are prepared, and
when the address of the arbitrary task is read out from said priority register and said order register, said task executing unit executes the relevant task program on the basis of the addresses in said program table and said data table and the data is accessed.

6. A system according to claim 2, wherein
a program table and a data table showing a program address and a data address corresponding to an arbitrary task are prepared, and
when the address of the arbitrary task is read out from said priority register and said order register, said task executing unit executes the relevant task program on the basis of the addresses in said program table and said data table and the data is accessed.

7. A system according to claim 3, wherein
a program table and a data table showing a program address and a data address corresponding to an arbitrary task are prepared, and
when the address of the arbitrary task is read out from said priority register and said order register, said task executing unit executes the relevant task program on the basis of the addresses in said program table and said data table and the data is accessed.

8. A task program control method comprising:
a storing step of storing information showing priorities of a plurality of tasks and orders-per-priority into a memory;
a priority reading step of reading out the priority of the task of the highest priority from said memory;
an order reading step of reading out order-per-priority data of the priority read out by said priority reading step;
a priority holding step of holding a value of the priority read out in said priority reading step into a priority register;
an order holding step of holding a value of the order in the priority read out in said priority reading step into an order register;
an order-per-priority control step of setting a value of the highest order in the order-per-priority data read out in said order reading step into said order register and, when the value in said order register is read out, setting said read-out value so as to become the lowest order at such timing in the case where it is read out next; and
a task executing step of reading out the values in said priority register and said order register as an address of a task which is executed next, executing said task, and after the execution, updating the information in said memory on the basis of a value which said task has and shows whether the task itself is continued or stopped.
